(19) United States
(12) Patent Application Publication
(10) Pub. No.: US 2017/0117091 A1
(43) Pub. Date: Apr. 27, 2017

(54) POWER CONVERTER TRANSFORMER WITH REDUCED LEAKAGE INDUCTANCE

(71) Applicant: Power Integrations, Inc., San Jose, CA (US)

(72) Inventors: Israel M. Serrano, Johns Creek, GA (US); Robert Aranda Martin, San Jose, CA (US); William M. Polivka, Campbell, CA (US)

(21) Appl. No.: 15/265,654

(22) Filed: Sep. 14, 2016

Related U.S. Application Data
(60) Provisional application No. 62/245,755, filed on Oct. 23, 2015.

(51) Int. Cl. H01F 27/40; H01F 27/32; H02M 3/335; H01F 27/28

(52) U.S. Cl. CPC H01F 27/40; H01F 27/2823; H01F 27/323; H02M 3/33523

(57) ABSTRACT

A transformer for use in a power converter includes a first winding including a plurality of layers wound around a magnetic core. A first exclusionary winding is wound around the magnetic core forming a first exclusionary winding layer. A first section of the plurality of layers of the first winding is wound closer to a center of the magnetic core than the first exclusionary winding layer. A second exclusionary winding is wound around the magnetic core forming a second exclusionary winding layer. The first and second exclusionary windings have an equal number of turns around the magnetic core. A second section of the plurality of layers of the first winding is wound around the magnetic core between the first exclusionary winding layer and the second exclusionary winding layer.

### CROSS-REFERENCE TO RELATED APPLICATIONS

This application claims the benefit of U.S. Provisional Application No. 62/245,755 filed on Oct. 23, 2015, the contents of which are incorporated herein by reference.

### BACKGROUND INFORMATION

Field of the Disclosure

The present invention relates generally to transformers, and more specifically transformers for use in power converters.

Background

Electronic devices use power to operate. Power supplies for electronic devices commonly use switched mode power converters to achieve high efficiency, small size and low weight. A flyback converter is a type of switched mode power converter that uses a transformer and a semiconductor switch to produce the voltages and currents typically required by electronic devices. The flyback converter generally uses a clamp circuit across a winding of the transformer to protect the switch from excessive voltage that may be produced by leakage inductance associated with the transformer.

Reduction or elimination of components in the clamp circuit may reduce the cost of the switch mode power supply while meeting standards for high efficiency and other regulatory requirements.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a schematic illustrating a power supply with a transformer that includes a pair of exclusionary windings in accordance with the teachings of the present invention.

FIG. 2A is a schematic of a transformer illustrating a pair of exclusionary windings in accordance with the teachings of the present invention.

FIG. 2B is a cross section of the transformer represented in the schematic of FIG. 2A that illustrates a pair of exclusionary windings in accordance with the teachings of the present invention.

FIG. 3A is a schematic illustrating a pair of exclusionary windings that are also two secondary windings in accordance with the teachings of the present invention.

FIG. 3B is a cross section of the transformer represented in the schematic of FIG. 3A in accordance with the teachings of the present invention.

FIG. 4A is a schematic of a transformer that illustrates a primary winding, a bias winding, and a pair of exclusionary windings that are also secondary windings in accordance with the teachings of the present invention.

FIG. 4B is a cross section of the transformer represented in the schematic of FIG. 4A in accordance with the teachings of the present invention.

FIG. 5A is a cross section of a transformer that illustrates a primary winding with z-wound layers, a bias winding, and a pair of exclusionary windings shown as two secondary windings in accordance with the teachings of the present invention.

FIG. 5B is a cross section of a transformer that illustrates a primary winding with c-wound layers, a bias winding, and a pair of exclusionary windings shown as two secondary windings in accordance with the teachings of the present invention.

FIG. 6A is a cross section of a transformer that illustrates a primary winding, a first secondary winding, a bias winding, and a second secondary winding in accordance with the teachings of the present invention.

FIG. 6B is a cross section of a transformer that illustrates a first secondary winding, a primary winding, a bias winding, and a second secondary winding in accordance with the teachings of the present invention.

FIG. 6C is a cross section of a transformer that illustrates a primary winding, a first secondary winding, a bias winding, and a second secondary winding in accordance with the teachings of the present invention.

FIG. 6D is a cross section of a transformer that illustrates a first secondary winding, a primary winding, a first bias winding, a second bias winding, and a second secondary winding in accordance with the teachings of the present invention.

FIG. 7 is a schematic illustrating a power supply with a pair of exclusionary windings shown as two secondary windings in accordance with the teachings of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Examples of a transformer with a pair of exclusionary windings that may be included with a power converter are described herein. In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or subcombinations in one or more embodiments or examples. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

Example transformers in accordance with the teachings of the present invention reduce leakage inductance such that a clamp circuit in a power supply can be reduced or eliminated. A transformer with reduced leakage inductance may increase the efficiency and lower the cost of the power supply by either eliminating the clamp circuit or by reducing its complexity. A transformer is a passive electrical element with at least two pairs of terminals that relies on the properties of magnetic fields to determine the relationships between the currents and the voltages at the terminals. Each winding of the transformer has two ends that correspond to one pair of terminals. Windings may conduct current and produce voltages between the ends of the windings.

Transformers that store energy and also transfer energy between windings are sometimes referred to as coupled inductors. In this disclosure the term transformer includes coupled inductors. The stored energy is contained within inductance that is associated with each winding. Perfect transformers can transfer all the energy received by one winding to all other windings. In other words, each winding of a perfect transformer is completely coupled to every other winding. Imperfections in practical transformers lead to incomplete coupling between windings that prevent all the energy received by one winding from transferring to another winding. The energy that is not transferred is contained within a leakage inductance that may be associated with one or more of the windings. Although the energy in the leakage inductance may be beneficial in some applications, in other applications it creates undesirable complexities such as excessive voltage excursions or unwanted loss of energy.

To reduce the leakage inductance, the transformer may be constructed with a portion of a winding sandwiched between a pair of exclusionary windings of equal turns. The ends of the exclusionary windings may be terminated such that current leaving the positive end of one exclusionary winding enters the positive end of the other exclusionary winding. Current in the exclusionary windings may oppose changes to magnetic flux between the exclusionary windings, reducing the leakage inductance associated with the energy that does not couple to other windings. In one such example, the winding that has a portion between the exclusionary windings may be a primary winding of the transformer in a flyback converter. In other examples, a pair of exclusionary windings may have no portions of other windings sandwiched between them.

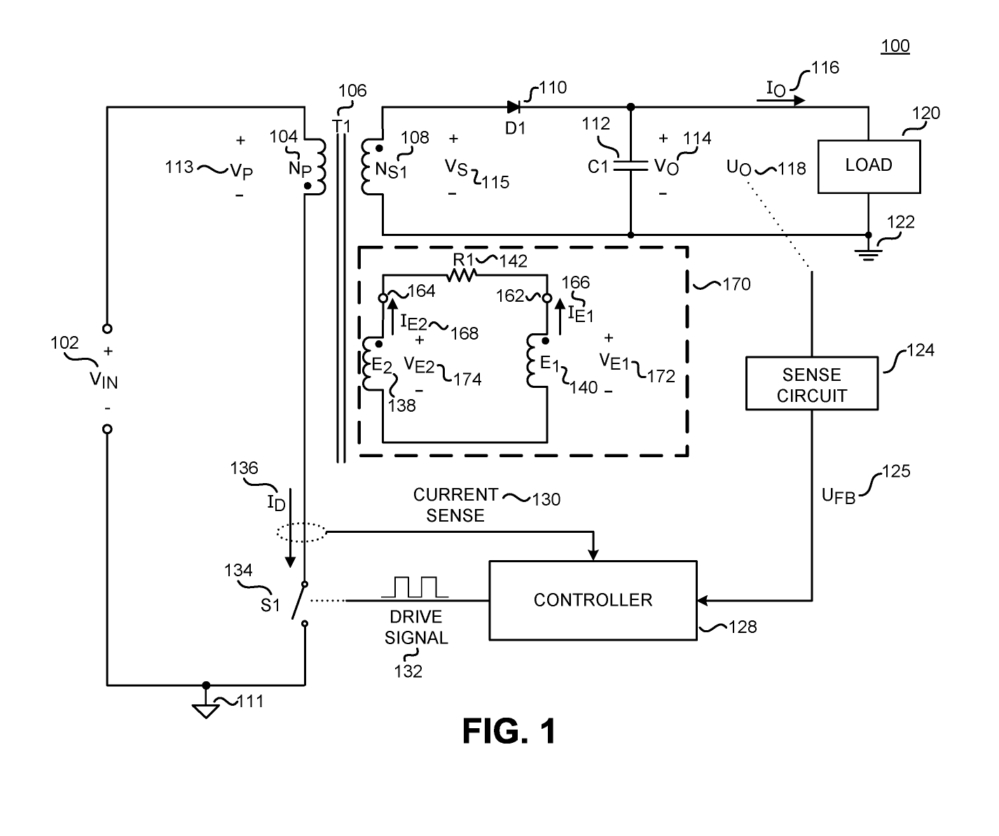

To illustrate, FIG. 1 shows an example power supply 100. Power supply 100 includes an energy transfer element T1 106 with a primary winding N_{P} 104, a secondary winding N_{S1} 108, and a pair of exclusionary windings 170. A primary winding N_{P} 104 may be referred to as input winding, and a secondary winding N_{S1} 108 may be referred to as an output winding. In another example, multiple output windings can provide a single output.

The primary winding N_{P} 104, secondary winding N_{S1} 108, first exclusionary winding E₁ 140 and second exclusionary winding E₂ 138 include the conventional dot polarity marking at one end of the winding. The dot polarity shows the polarity of the voltage between the ends of the winding. All ends with the dot have the same polarity with respect to the end without the dot. The end with the dot may be positive or negative, depending whether the power switch is ON or OFF. In other words, when the dotted end of one winding is positive with respect to its non-dotted end, the dotted end of every other winding will be positive with respect to its non-dotted end, and when the dotted end of one winding is negative with respect to its non-dotted end, the dotted end of every other winding will be negative with respect to its non-dotted end.

Power supply 100 also includes a rectifier that is a diode D1 110, an output capacitor C1 112, a sense circuit 124, and a controller 128. The input voltage V_{IN} 102 is coupled to the energy transfer element T1 106 that produces a primary voltage V_{P} 113 across primary winding N_{P} 104. Power supply 100 uses the energy transfer element T1 106 to transfer energy from the primary winding N_{P} 104 to the secondary winding N_{S1} 108. The dotted end of primary winding N_{P} 104 is further coupled to power switch S1 134, which is then further coupled to the input return 111.

The dotted end of secondary winding N_{S1} 108 of the energy transfer element T1 106 is coupled to the anode of rectifier diode D1 110. An output current I_{O} 116 is delivered to the load 120. The cathode of rectifier diode D1 110 is coupled to the positive terminal of an output capacitor C1 112 and the positive terminal of load 120. The negative terminal of output capacitor C1 112, the non-dotted end of secondary winding N_{S1} 108, and the negative terminal of the load 120 are coupled through a common node that is output return 122.

In the example, input voltage V_{IN} 102 is positive with respect to input return 111, and output voltage V_{O} 114 is positive with respect to output return 122. The example of FIG. 1 shows galvanic isolation between the input return 111 and the output return 122. In other words, a dc voltage applied between input return 111 and output return 122 will produce substantially zero current. Therefore, circuits electrically coupled to the primary winding N_{P} 104 are galvanically isolated from circuits electrically coupled to the secondary winding N_{S1} 108.

A sense circuit 124 is coupled to sense an output quantity U_{O} 118 and to provide a feedback signal U_{FB} 125, which is representative of the output quantity U_{O} 118. Feedback signal U_{FB} 125 may be a voltage signal or a current signal. In one example, the sense circuit 124 may sense the output quantity U_{O} 118 from an additional winding included in the energy transfer element T1 106. In another example, there may be galvanic isolation (not shown) between the controller 128 and the sense circuit 124. In yet another example, there may be galvanic isolation (not shown) within the controller 128. The galvanic isolation could be implemented by using devices such as an opto-coupler, a capacitor, or a magnetic coupling. In a further example, the sense circuit 124 may utilize a voltage divider to sense the output quantity U_{O} 118 from the output of the power supply 100. Controller 128 is coupled to the sense circuit 124 and receives the feedback signal U_{FB} 125 from the sense circuit 124. The controller 128 further includes terminals for receiving a current sense signal 130 and for providing a drive signal 132 to switch power switch S1 134.

In addition, the drive signal 132 may be used to control various switching parameters. Examples of such parameters may include switching frequency, duty cycle, and switching speed of the power switch S1 134.

Power switch S1 134 is opened and closed in response to the drive signal 132 received from the controller 128. It is generally understood that a switch that is closed may conduct current and is considered ON, whereas a switch that is open cannot conduct current and is considered OFF. In the example of FIG. 1, power switch S1 134 controls a drain current I_{D} 136 in response to controller 128 to meet a specified performance of the power supply 100. In some embodiments, the power switch S1 134 may be a transistor.

A pair of exclusionary windings 170 includes a first exclusionary winding E1 140 and a second exclusionary winding E2 138 that have the same number of turns. The pair of exclusionary windings acts to reduce the leakage inductance (not shown in FIG. 1) of energy transfer element T1 106.

The first exclusionary winding E1 140 produces a first exclusionary voltage V_{E1} 172 and conducts a first exclusionary current I_{E1} 166 at a terminal 162. The secondary winding E2 138 produces a second exclusionary voltage V_{E2} and conducts a second exclusionary current I_{E2} 168 at a terminal 164. Although both exclusionary windings E1 140 and E2 138 have the same number of turns, exclusionary voltages V_{E1} and V_{E2} will in general be different because the exclusionary windings do not enclose the same amount of magnetic flux as a result of the construction of the transformer shown later in this disclosure. The only time the voltages will be the same is when both are zero. The difference between the flux enclosed by exclusionary winding E1 140 and the flux enclosed by exclusionary winding E2 138 is leakage flux. It is appreciated that leakage flux may reside at other places internal and external to the transformer, and not all the leakage flux associated with the transformer is necessarily confined to the region between the exclusionary windings.

Since the exclusionary windings conduct the same current in the example of FIG. 1, first exclusionary current I_{E1} 166 is the same magnitude and opposite sign as second exclusionary current I_{E2} 168. In other words, the difference in exclusionary voltages V_{E1} 172 and V_{E2} 174 produces current that circulates in the exclusionary windings. In operation, current circulates in the exclusionary windings such that it reduces the leakage flux between the exclusionary windings, effectively reducing the leakage inductance in the transformer. Drain current I_{D} 136, exclusionary current I_{E1} 166, and exclusionary current I_{E2} 168 will in general be pulsating currents, whereas output current I_{O} 116 will in general be a substantially non-pulsating current.

In the example of FIG. 1 a resistor R1 142 is coupled between the first and second exclusionary windings to limit the current through the two windings. In some cases, the resistor R1 142 can have a value of zero. When the value of resistor R1 142 is zero, the current is limited by the inherent resistance of the exclusionary windings, not shown in FIG. 1. It is usually desirable to make the resistance that limits the current as small as possible to achieve the greatest reduction in leakage inductance, although in some examples the resistor R1 142 may be chosen to adjust the leakage inductance to a desired value. It is not necessary to make the terminals of the exclusionary windings accessible outside the transformer.

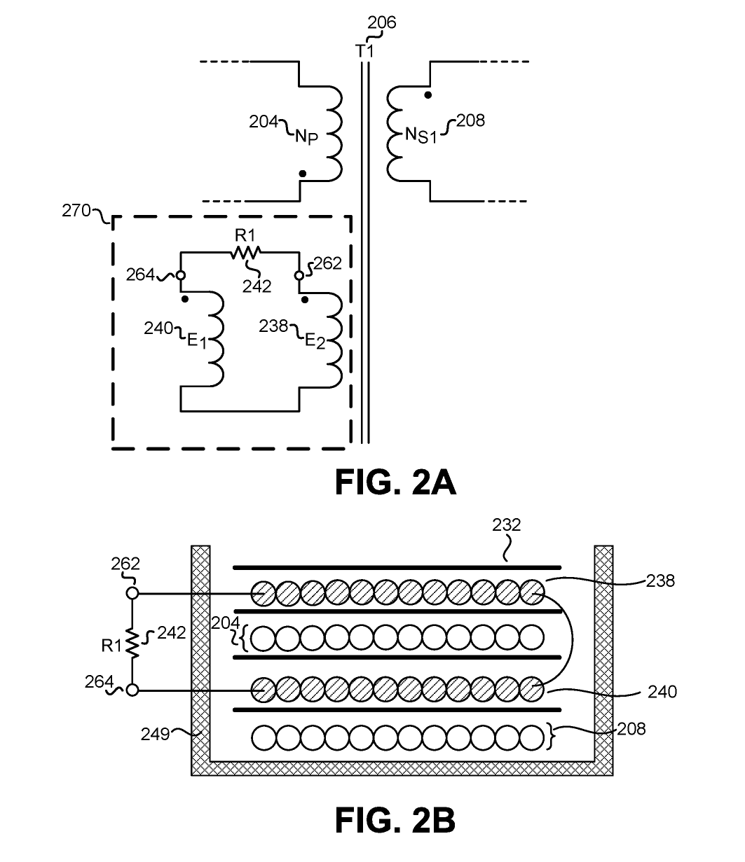

FIG. 2A is a schematic of a transformer with exclusionary windings that may be used in any power supply that can benefit from a reduction in leakage inductance. Some examples include forward converters and variants of converters that use tapped inductors.

Included in FIG. 2A is an energy transfer element T1 206 with a primary winding N_{P} 204, a secondary winding N_{S1} 208, and a pair of exclusionary windings 270.

The pair of exclusionary windings 270 includes a first exclusionary winding E1 240, and a second exclusionary winding E2 238. A resistor R1 242 is coupled to the first exclusionary winding E1 240 and second exclusionary winding E2 238 through terminals 264 and 262 respectively.

FIG. 2B illustrates a cross section of the windings for the transformer represented in the schematic of FIG. 2A. The cross section shows the arrangement of turns of wire that would form coils around a core of material of relatively high magnetic permeability, where the bottom of the illustration would be closest to the core. The exclusionary windings are marked as shaded circles. FIG. 2B includes a bobbin 249, one layer of a secondary winding 208, one layer of a first exclusionary winding 240, one layer of a primary winding 204, and one layer of a second exclusionary winding 238. It is appreciated that a bobbin is not required to wind electrical conductors around a core of magnetic material, and that in some applications, such as for example those that use toroidal magnetic cores, wires are typically wound on the magnetic core without a bobbin. A layer of insulating tape 232 separates each winding layer. The first exclusionary winding 240 and second exclusionary winding 238 are wound in a C configuration (c-wound). In the example of FIG. 2B, the entire primary winding 204 is sandwiched between the first exclusionary winding 240 and the second exclusionary winding 238. The first and secondary exclusionary windings are coupled to a first resistor R1 242 through terminals 264 and 262 respectively.

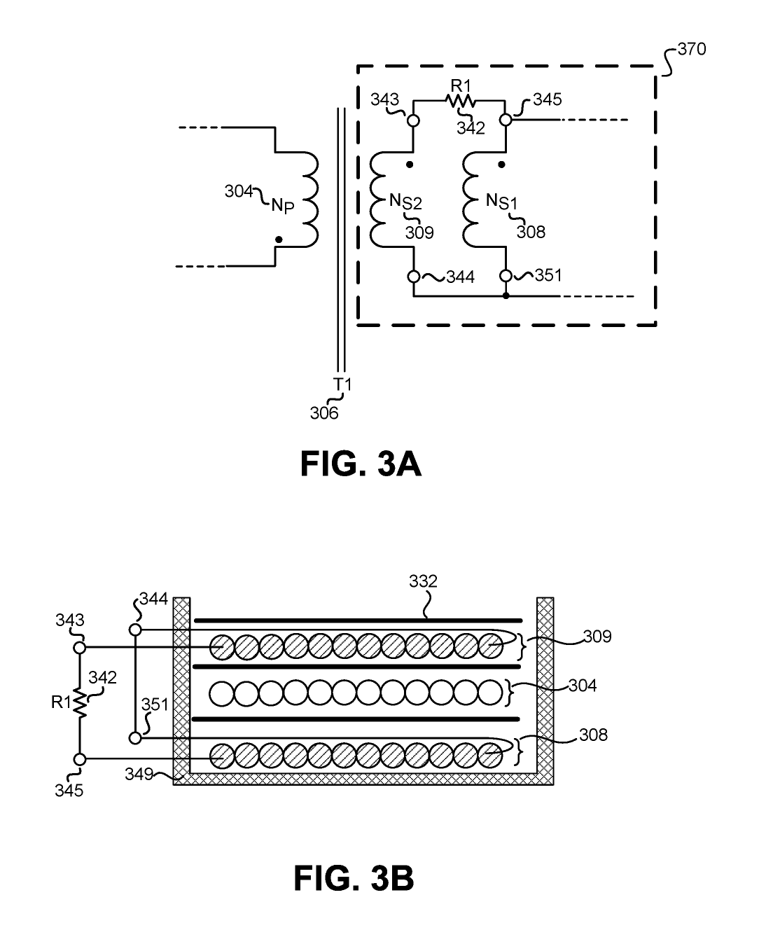

FIG. 3A is a schematic of a transformer that includes pair of exclusionary windings that provides multiple functions. The pair of exclusionary windings reduces the leakage flux between the exclusionary windings and provides power to a load not shown in the diagram. The pair of exclusionary windings 370 includes a first secondary winding N_{S1} 308, and a second secondary winding N_{S2} 309. One end of a resistor R1 342 is coupled to terminal 345 at the dotted end of the first secondary winding N_{S1} 308, and the other end of resistor R1 342 is coupled to terminal 343 at the dotted end of the second secondary winding N_{S2} 309. In some examples, the resistor R1 342 can have a value of zero. Furthermore, terminal 344 at the non-dotted end of the second secondary winding N_{S2} 309 is coupled to terminal 351 at the non-dotted end of the first secondary winding N_{S1} 308 by a common node. In other words, the example of FIG. 3A shows exclusionary windings that are also secondary windings that may provide power to a single output.

FIG. 3B illustrates a cross section of the windings for the transformer represented in the schematic of FIG. 3A. The cross section shows the arrangement of wire that would form coils around a core of material of relatively high magnetic permeability, where the bottom of the illustration would be closest to the core. The exclusionary windings are marked as shaded circles. FIG. 3B includes a bobbin 349, one layer of a secondary winding 308, one layer of a primary winding 304, and one layer of a secondary winding 309. A layer of insulating tape 332 separates each winding layer. In the example of FIG. 3B, the entire primary winding 304 is sandwiched between the first secondary layer 308 and the second secondary layer 309. The first secondary and second secondary windings are coupled to a first resistor R1 342 through terminals 345 and 343 respectively.

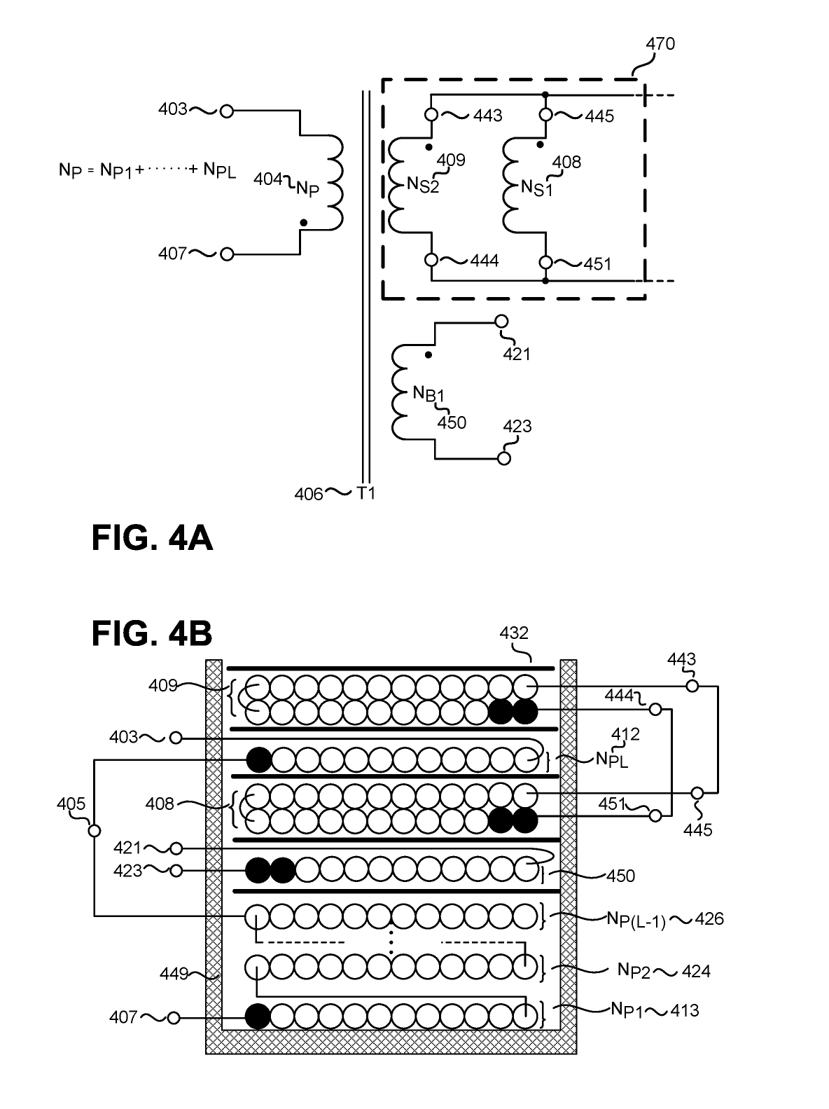

FIG. 4A is a schematic of a transformer that includes a bias winding and exclusionary windings that may be used in any power supply that can benefit from a reduction in leakage inductance.

Included in FIG. 4A is an energy transfer element T1 406, primary winding N_{P} 404, a pair of exclusionary windings 470, and a bias winding N_{B1} 450. The bias winding N_{B1} 450 includes terminals 421 and 423.

The pair of exclusionary windings can reduce the leakage flux between the exclusionary windings and provide power to a load not shown in the diagram. The pair of exclusionary windings 470 includes a first secondary winding N_{S1} 408 and a second secondary winding N_{S2} 409. Terminal 444 of the second secondary winding N_{S2} 409 is coupled to terminal 451 of the first secondary winding N_{S1} 408 by a common node. Terminal 443 of the second secondary winding N_{S2} 409 is coupled to terminal 445 of the first secondary winding N_{S1} 408 by a common node.

The primary winding N_{P} 404 includes a first terminal 403 and a second terminal 407. The primary winding can comprise of multiple layers (N_{P1}+N_{P2}+ . . . . +N_{PL}) where N_{P1} is the initial layer and N_{PL} is the last layer of L layers. In one example, the last layer of the primary winding is wrapped between the two exclusionary windings. In this example, the two exclusionary windings are the first secondary winding N_{S1} 408 and second secondary winding N_{S2} 409.

FIG. 4B illustrates a cross section of the windings for the transformer represented in the schematic of FIG. 4A. The cross section shows the arrangement of wire that would form coils around a core of material of relatively high magnetic permeability, where the bottom of the illustration would be closest to the core. The solid circles in FIG. 4B indicate the dotted ends of the windings. A single solid circle indicates the beginning of the winding. Two adjacent solid circles indicate two strands of wire side-by-side (a bifilar winding). A bifilar winding is generally an untwisted pair of insulated wires wound together from start to finish. Multi-filar winding techniques may reduce the size and improve the performance of transformers that operate at relatively high currents.

FIG. 4B includes a bobbin 449, an initial layer N_{P1} 413 of the primary winding, a second layer N_{P2} 424 of the primary winding, a next-to-last layer N_{P(L-1)} 426 of the primary winding, one layer of the bias winding 450, two layers of a first secondary winding 408, last layer N_{PL} 412 of the primary winding, and two layers of a second secondary winding 409. The initial layer N_{P1} 413 of the primary winding N_{P} 404 and the next layer N_{P2} 424 of the primary winding N_{P} 414 are wound in a Z configuration (z-wound). In other examples, the initial layer N_{P1} 413 and the next layer N_{P2} 424 of the primary winding N_{P} 404 can be wound in a C configuration (c-wound). A z-wound configuration may be used in applications where lower transformer capacitance is required, whereas a c-wound may be used in applications for simpler transformer constructions.

In other examples, layers of any winding may be either c-wound or z-wound with respect to adjacent layers of the same winding, even when there may be one or more intervening layers of a different winding. The next-to-last primary layer N_{P(L-1)} 426 is coupled to the last layer N_{PL} 412 of the primary winding through terminal 405. In the example of FIG. 4B, a layer of insulating tape 432 separates layers of different windings. The first secondary winding 408 and second secondary winding 409 are coupled through terminals 443, 444, 445, and 451. It is appreciated that the conductors of a winding may not necessarily have a round cross section, and that winding layers may not necessarily occupy the entire width of the bobbin 449. In some examples a winding layer may have only a single turn. In some examples, a single-turn of a conductor with a rectangular cross section may form a winding layer that occupies the entire width of the bobbin 449 in a configuration known in the art as a foil winding, sometimes referred to as a tape winding.

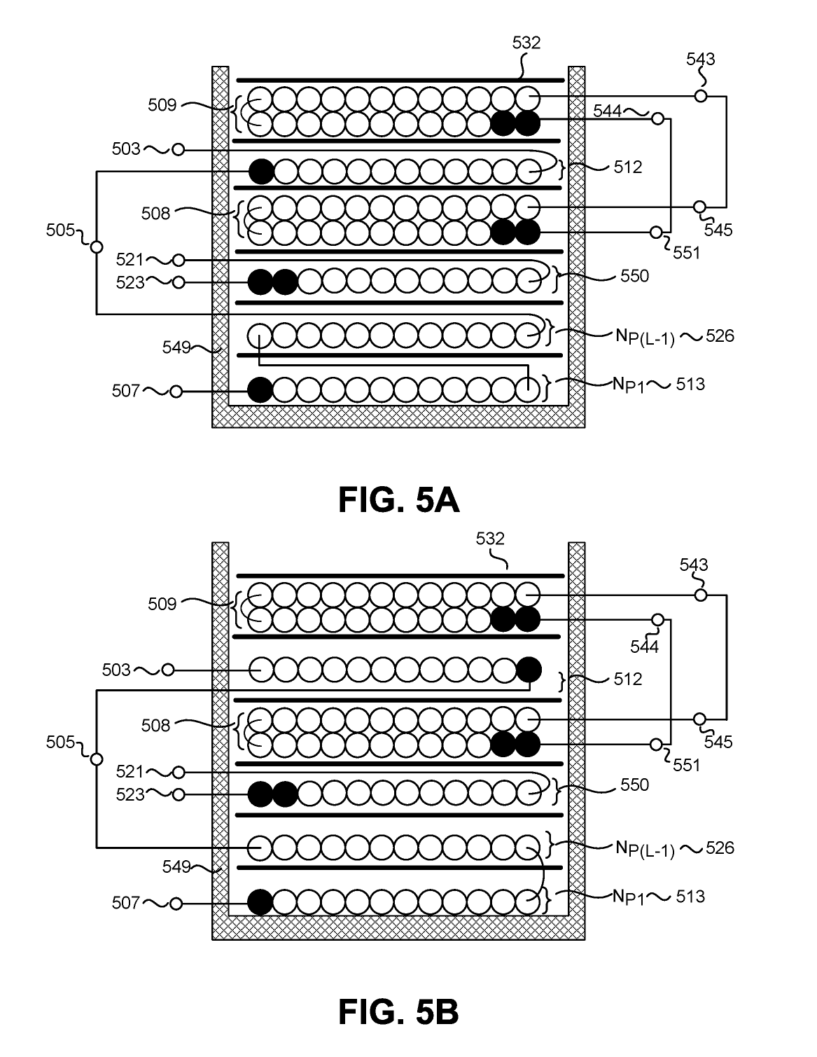

FIG. 5A illustrates a cross section of the windings for a transformer similar to FIG. 4B, with total number of three layers (L=3) for the primary winding. The cross-section shows the arrangement of turns of wire that would form coils around a core of material of relatively high magnetic permeability, where the bottom of the illustration would be closest to the core. FIG. 5A includes a bobbin 549, an initial layer N_{P1} 513 of a primary winding, a second layer N_{P(L-1)} 526 of a primary winding, a layer of a bias winding 550, two layers of a first secondary winding 508, a last layer N_{P} 512 of the primary winding, and two layers of a second secondary winding 509. In the example, the last layer N_{P} 512 of the primary winding is sandwiched between the first secondary winding 508 and the second secondary winding 509. A layer of insulating tape 532 separates layers of different windings. The first secondary winding and second secondary winding are coupled through terminals 543, 544, 545, and 551. The initial layer of the primary winding N_{P1} 513 and the next layer of the primary winding N_{P(L-1)} 526 are z-wound, whereas the last layer 512 of the primary winding is c-wound with respect to the preceding primary layer 526.

FIG. 5B illustrates a cross section of the windings for the transformer similar to FIG. 5A, except the first layer of the primary winding and next-to-last layer of the primary winding are c-wound. In addition, the next-to-last layer of the primary winding and the last layer of the primary winding are z-wound. The cross-section shows the arrangement of turns of wire that would form coils around a core of material of relatively high magnetic permeability, where the bottom of the illustration would be closest to the core. FIG. 5B includes a bobbin 549, an initial layer N_{P1} 513 of a primary winding, a next-to-last layer of a primary winding N_{P(L-1)} 526, a layer of a bias winding 550, two layers of a first secondary winding 508, a last layer 512 of a primary winding, and two layers of a second secondary winding 509. In the example, the last layer 512 of the primary winding is sandwiched between the first secondary winding 508 and the second secondary winding 509. A layer of insulating tape 532 separates layers of different windings. The first secondary winding 508 and second secondary winding 509 are coupled through terminals 543, 544, 545, and 551.

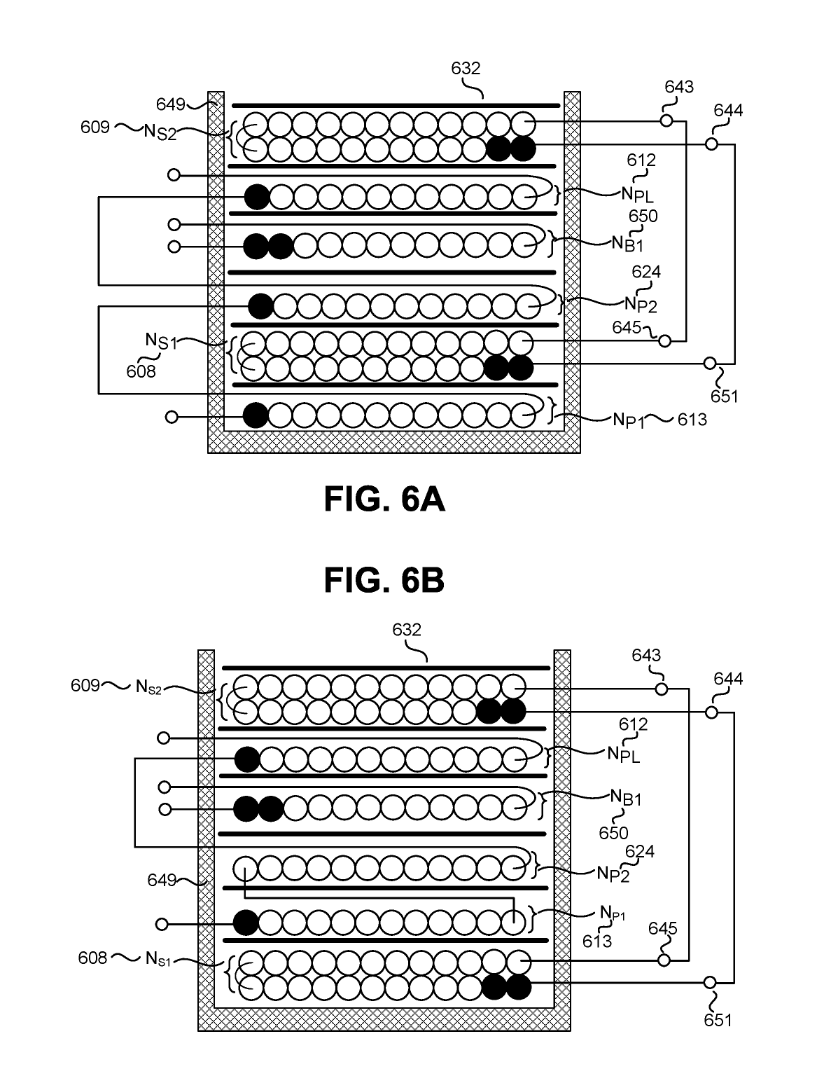

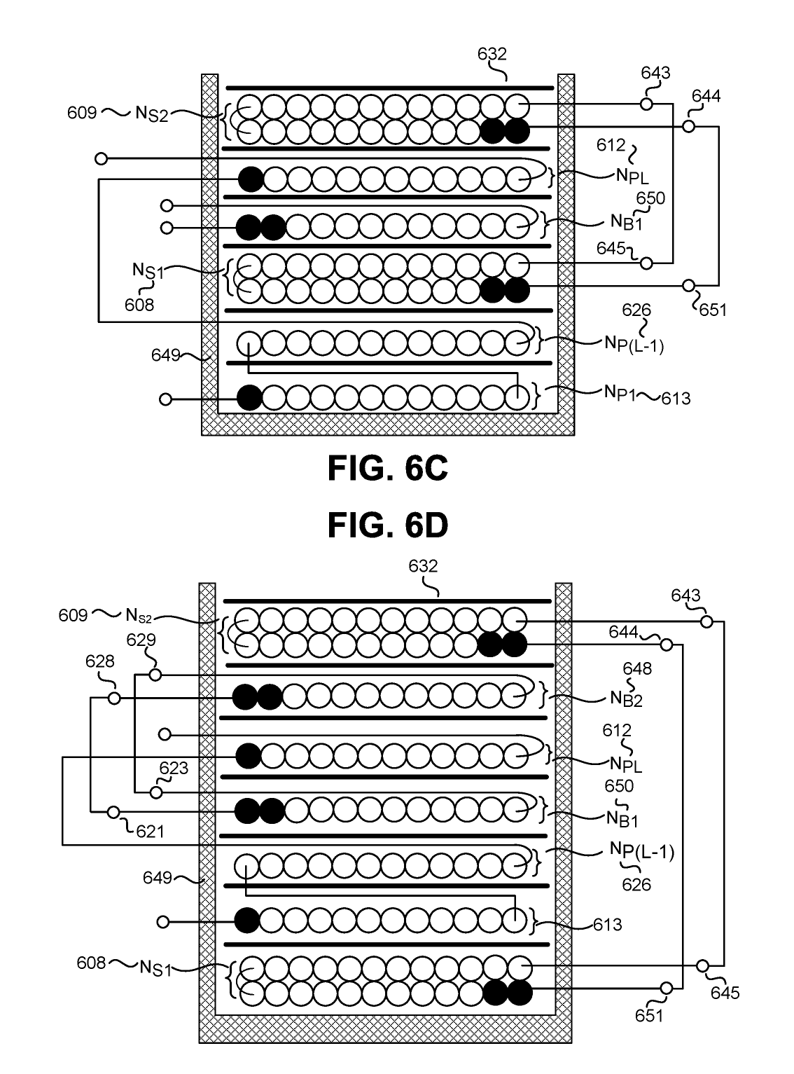

FIGS. 6A through 6D are cross sections of example transformers that illustrate different combinations for the placement of the exclusionary windings that are also secondary (output) windings. In general, these variations provide the same effect is the previously described examples by affecting the magnetic fields between exclusionary windings. The cross-section shows the arrangement of turns of wire that would form coils around a core of material of relatively high magnetic permeability, where the bottom of the illustration would be closest to the core.

FIG. 6A includes a bobbin 649, an initial layer N_{P1} 613 of a primary winding, a first two layer secondary winding N_{S1} 608, a next-to-last layer N_{P2} 624 of a primary winding, a single-layer bias winding N_{B1} 650, a last layer N_{PL} 612 of a primary winding, and second two-layer secondary winding N_{S2} 609. A layer of insulating tape 632 separates layers of different windings. The first two-layer secondary winding and second two-layer secondary winding are coupled through terminals 643, 644, 645, and 651.

FIG. 6B includes a bobbin 649, a first two-layer secondary winding N_{S1} 608, an initial layer N_{P1} 613 of a primary winding, a second layer N_{P2} 624 of a primary winding, a single-layer bias winding N_{B1} 650, a last layer N_{PL} 612 of a primary winding, and a second two-layer secondary winding N_{S2} 609. A layer of insulating tape 632 separates layers of different windings. The first secondary winding and second secondary winding are coupled through terminals 643, 644, 645, and 651.

FIG. 6C includes a bobbin 649, an initial layer N_{P1} 613 of a primary winding, a next-to-last layer N_{P(L-1)} 626 of a primary winding, a first two-layer secondary winding N_{S1} 608, a single-layer bias winding N_{B1} 650, a last layer N_{PL} 612 of a primary winding, and a second two-layer second secondary winding N_{S2} 609. A layer of insulating tape 632 separates layers of different windings. The two secondary windings are coupled through terminals 643, 644, 645, and 651.

FIG. 6D includes a bobbin 649, a first two-layer secondary winding N_{S1} 608, an initial layer N_{P1} 613 of a primary winding, a next-to-last layer N_{P(L-1)} 626 of a primary winding, a single-layer bias winding N_{B1} 650, a last layer N_{PL} 612 of a primary winding, a second single-layer bias winding N_{B2} 648, and a second two-layer secondary winding N_{S2} 609. A layer of insulating tape 632 separates layers of different windings. The first two-layer secondary winding and the second two-layer secondary winding are coupled through terminals 643, 644, 645, and 651. The first bias winding N_{B1} 650 and second bias winding N_{B2} 648 are coupled through terminals 621, 623, 628, and 629.

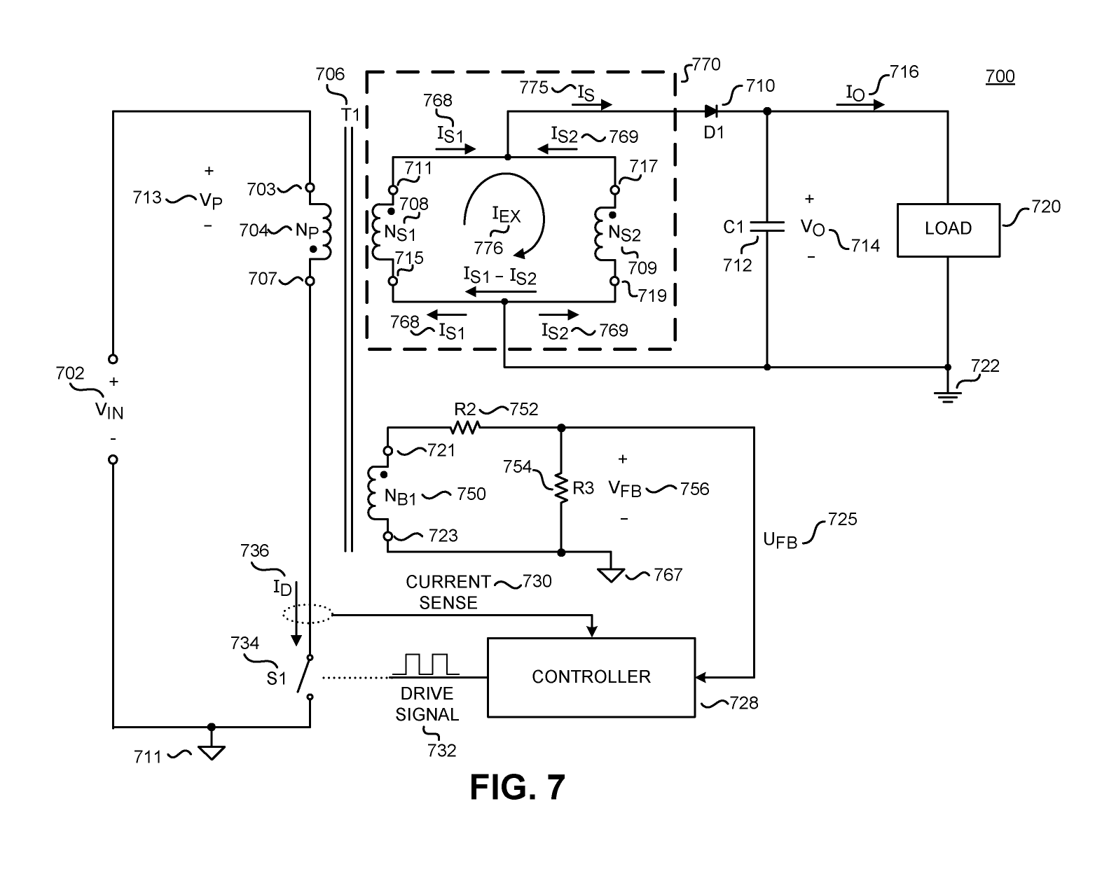

FIG. 7 is a schematic illustrating a power converter with a pair of exclusionary windings shown as two secondary windings in accordance with the teachings of the present invention.

To illustrate, FIG. 7 shows an example power supply 700. Power supply 700 includes an energy transfer element T1 706 with a primary winding N_{P} 704, a secondary winding N_{S1} 708, a second secondary winding N_{S2} 709, a bias winding N_{B1} 750, and a pair of exclusionary windings 770. A primary winding N_{P} 704 may be a referred to as an input winding, and secondary windings may be referred to as output windings. In this example, multiple secondary windings can provide a single output.

All the windings include a dot marking to indicate the polarity of voltage at the ends of the windings. All dotted ends have the same polarity with respect to the non-dotted ends. In FIG. 7, when node 707 is negative with respect to node 703, node 711 is negative with respect to 715, and node 721 is negative with respect to node 723. Similarly, when node 707 is positive with respect to node 703, node 711 is positive with respect to node 715, and node 721 is positive with respect to node 723.

Power supply 700 also includes a rectifier diode D1 710, an output capacitor C1 712, and a controller 728. The input voltage V_{IN} 702 is coupled to the energy transfer element T1 706. Power supply 700 uses the energy transfer element T1 706 to transfer energy from the primary winding N_{P} 704 to the first secondary winding N_{S1} 708 and to the second secondary winding N_{S2} 709. The primary winding N_{P} 704 is further coupled to power switch S1 734, which is then further coupled to the input return 711.

The first secondary winding N_{S1} 708 and the second secondary winding N_{S2} 709 of the energy transfer element T1 706 are coupled to the rectifier diode D1 710. In the example in FIG. 7, the secondary windings N_{S1} 708 and N_{S2} 709 are coupled to the anode of the diode. The positive terminals of output capacitor C1 712 and the load 720 are coupled through a common node. The negative terminals of output capacitor C1 712 and load 720 are coupled to an output return 722. The dotted ends of secondary windings N_{S2} 709 and N_{S1} 708 are coupled through a common node, and the non-dotted ends of secondary windings N_{S2} 709 and N_{S1} 708 are coupled through a different common node that is the output return 722 in the example of FIG. 7.

In the example, input voltage V_{IN} 702 is positive with respect to input return 711, and output voltage V_{O} 714 is positive with respect to output return 722. The example of FIG. 7 shows galvanic isolation between the input return 711 and the output return 722. In other words, a dc voltage applied between input return 711 and output return 722 will produce substantially zero current. Therefore, circuits electrically coupled to the primary winding N_{P} 704 are galvanically isolated from circuits electrically coupled to the first secondary winding N_{S1} 708 and second secondary winding N_{S2} 709.

The bias winding N_{B1} 750 is coupled to resistor R2 752 and resistor R3 754, and bias return 767. In the example shown, the feedback voltage V_{FB} 756 across resistor R3 754 is utilized as the feedback signal U_{FB} 725 and is received by controller 728. The controller 728 further includes terminals for receiving the current sense signal 730 and for providing the drive signal 732 to power switch S1 734.

In addition, the drive signal 732 may be used to control various switching parameters. Examples of such parameters may include switching frequency, duty cycle, and switching speed of the power switch S1 734.

Power switch S1 734 is opened and closed in response to the drive signal 732 received from the controller 728. It is generally understood that a switch that is closed may conduct current and is considered ON, whereas a switch that is open cannot conduct current and is considered OFF. In the example of FIG. 7, power switch S1 734 controls a drain current I_{D} 736 in response to controller 728 to meet a specified performance of the power supply 700. In some embodiments, the power switch S1 734 may be a transistor.

In operation, the bias winding N_{B1} 750 produces a feedback voltage V_{FB} 756 that is responsive to the output voltage V_{O} 714 when the output rectifier diode D1 710 coupled to the first secondary winding and second secondary winding conducts. The feedback voltage and feedback signal are representative of the output voltage V_{O} 714 during at least a portion of an OFF time of switch S1 734. During the ON time of the switch S1 734, the bias winding produces a voltage V_{FB} 756 in response to the input voltage V_{IN} 704. Resistors R2 752 and R3 754 are utilized to scale down the voltage of the bias winding N_{B1} 750.

A pair of exclusionary windings 770 includes a first secondary winding N_{S1} 708 and a second secondary winding N_{S2} 709 that have the same number of turns. The pair of exclusionary windings acts to reduce the leakage inductance (not shown in FIG. 7) of energy transfer element T1 706 and to provide power to the load 720.

The first secondary winding N_{S1} 708 conducts a first secondary current I_{S1} 768 at terminals 711 and 715. The second secondary winding N_{S2} 709 conducts a second secondary current I_{S2} 760 at terminals 717 and 719. The sum of the secondary currents to be received by rectifier diode D1 710 is expressed as

I_{S}=I_{S1}+I_{S2} (1)

The exclusionary current for reducing the leakage inductance between the first secondary winding N_{S1} and second secondary winding N_{S2} can be expressed by the equation

I_{EX}=I_{S1}−I_{S2} (2)

Whereby the solution of the two linear equations for the first secondary current and second secondary current results in

$$\begin{matrix}{I}_{S 1} = \frac{{I}_{S} + {I}_{EX}}{2} & ( 3 ) \\ {I}_{S 2} = \frac{{I}_{S} - {I}_{EX}}{2} & ( 4 )\end{matrix}$$

In operation, a difference in current between the first secondary current I_{S1} 768 and second secondary current I_{S2} 769 circulates in the first secondary winding and second secondary winding such that it reduces the leakage flux between the secondary windings, effectively reducing the leakage inductance in the transformer, while the sum of the first secondary current I_{S1} 768 and the second secondary current I_{S2} 769 delivers power to the load. Currents I_{D} 736, I_{S1} 768, I_{S2} 769, I_{EX} 776, and I_{S} 775 will in general be pulsating, whereas load current I_{O} 720 will be substantially non-pulsating. It is appreciated that the expressions above are generally valid when the inherent resistance of the secondary windings is equal and negligible.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

These modifications can be made to examples of the invention in light of the above detailed description. The terms used in the following claims should not be construed to limit the invention to the specific embodiments disclosed in the specification and the claims. Rather, the scope is to be determined entirely by the following claims, which are to be construed in accordance with established doctrines of claim interpretation. The present specification and figures are accordingly to be regarded as illustrative rather than restrictive.

What is claimed is:

1. A transformer for use in a power converter, comprising:
a first winding including a plurality of layers wound around a magnetic core;
a first exclusionary winding forming a first exclusionary winding layer, wherein a first section of the plurality of layers of the first winding is wound closer to a center of the magnetic core than the first exclusionary winding layer; and
a second exclusionary winding wound around the magnetic core forming a second exclusionary winding layer, wherein the first and second exclusionary windings have an equal number of turns around the magnetic core, wherein a second section of the plurality of layers of the first winding is wound around the magnetic core between the first exclusionary winding layer and the second exclusionary winding layer.

2. The transformer of claim 1 wherein the first and second exclusionary windings are coupled together in parallel.

3. The transformer of claim 2 further comprising a resistor coupled in series between the first and second exclusionary windings to limit an amount of current through the first and second exclusionary windings.

4. The transformer of claim 3 wherein the resistor has a resistance value greater than or equal to zero.

5. The transformer of claim 1 wherein the first winding is a primary winding and wherein the power converter is a flyback power converter, wherein the first and second exclusionary windings reduce leakage inductance.

6. The transformer of claim 5 wherein the first and second exclusionary windings are coupled to provide a first secondary winding and a second secondary winding of the power converter.

7. The transformer of claim 6 wherein the transformer further comprises a bias winding wound around the magnetic core forming a bias winding layer.

8. The transformer of claim 7 wherein the bias winding layer is wound around the magnetic core between the first section of the plurality of layers of the first winding and first exclusionary winding layer.

9. The transformer of claim 6 wherein the second section of the plurality of layers of the first winding is a last layer of the first winding wound around the magnetic core.

10. The transformer of claim 1 wherein the first winding is a c-wound winding.

11. The transformer of claim 1 wherein the first winding is a z-wound winding.

12. The transformer of claim 1 further comprising a layer of tape disposed between layers of the first winding.

13. The transformer of claim 1 further comprising a terminal coupled between a last layer of the first winding and a second to last layer of the first winding wound around the magnetic core.

14. The transformer of claim 1 wherein the first and second exclusionary windings each include one or more layers wound around the magnetic core.

15. A flyback power converter, comprising:
a transformer coupled between an input of the power converter and an output of the power converter, the transformer including:
a primary winding including a plurality of layers wound around a magnetic core;
a first exclusionary winding wound around the magnetic core forming a first exclusionary winding layer, wherein a first section of the plurality of layers of the primary winding is wound closer to a center of the magnetic core than the first exclusionary winding layer; and
a second exclusionary winding wound around the magnetic core forming a second exclusionary winding layer, wherein the first and second exclusionary windings have an equal number of turns around the magnetic core, wherein a second section of the plurality of layers of the primary winding is wound around the magnetic core between the first exclusionary winding layer and the second exclusionary winding layer, wherein the first and second exclusionary windings reduce leakage inductance, wherein the first and second exclusionary windings are coupled in parallel to provide a first secondary winding and a second secondary winding that are coupled to provide power to a load coupled to the output of the power converter;
a power switch coupled to the primary winding and an input of the power converter; and
a controller coupled to generate a drive signal to control switching of the power switch in response to a feedback signal representative of the output of the power converter to regulate a transfer of energy from an input of the power converter to the output of the power converter.

16. The power converter of claim 15 wherein the transformer further comprises a bias winding wound around the magnetic core forming a bias winding layer, wherein the bias winding layer is wound around the magnetic core between the first section of the plurality of layers of the first winding and first exclusionary winding layer.

17. The power converter of claim 16 wherein the bias winding is coupled to provide the feedback signal to the controller.

18. The power converter of claim 15 wherein the second section of the plurality of layers of the first winding is a last layer of the primary winding wound around the magnetic core.

19. The power converter of claim 15 wherein the primary winding is a c-wound winding.

20. The power converter of claim 15 wherein the primary winding is a z-wound winding.

21. The power converter of claim 15 further comprising a layer of tape disposed between the plurality of layers of the primary winding.

22. The power converter of claim 15 further comprising a terminal coupled between a last layer of the primary winding and a second to last layer of the primary winding wound around the magnetic core.

23. The power converter of claim 15 wherein the first and second exclusionary windings each include one or more layers wound around the magnetic core.
